(19) United States
(12) Patent Application Publication
(10) Pub. No.: US 2025/0250850 A1
(43) Pub. Date: Aug. 7, 2025

(54) Tension device for an endless operating loop of a screen

(71) Applicant: Coulisse B.V., Enter (NL)

(72) Inventor: Wouter Hendriks, Enschede (NL)

(21) Appl. No.: 18/433,286

(22) Filed: Feb. 5, 2024

(51) Int. Cl. E06B 9/326; E06B 9/324

(52) U.S. Cl. CPC E06B 9/326; E06B 9/324

(57) ABSTRACT

The invention has for its object to provide a tension device for an endless operating loop that does fulfill these latest requirements for child safety, as described in the ANSI/WCMA A100.1-2022. The tension device comprises a locking element for locking the slidable member in a locked position in the housing, wherein in the locked position of the slidable member the one or more immobilization elements immobilize the endless operating loop in the non-operating position.

The invention relates to a tension device for an endless operating loop for operating a screen, wherein the tension device comprises:
a housing for receiving part of the endless operating loop;
a slidable member arranged in the housing;
wherein the slidable member is provided with a loop guide for the endless operating loop;
a biasing member arranged in the housing to push against the slidable member to apply tension to the endless operating loop;
one or more immobilization elements arranged in the housing that substantially immobilize the endless operating loop in a non-operating position upon engagement with the endless operating loop.

In view of child safety regulations loose operating loops of cords or chains have not been allowed for a few years now and each window covering operating loop must be permanently equipped with a tension device to attach the loose operating loop to a wooden substrate. Current regulations dictate that if the tension device is not installed on a substrate, it must block the operation of the window covering. This is often solved by an immobilization element in the tension device immobilizing the operating loop in a non-operating position.

A tension device according to the preamble is known from EP1980706. The known tension device has an abutment member that functions to immobilize the operating loop prior to installation. During installation the abutment member needs to be disengaged from the operating loop and fixed to the substrate together with the tension device in a position wherein the operating loop is correctly tensioned in an operating position.

When the tension on the operating loop drops, which may happen over time, the biasing member automatically pushes the slidable member with the loop guide towards the abutment member and when the operating loop contacts the abutment member the operating loop is immobilized in the non-operating position.

The known tension device has the drawback that a user can nevertheless still operate the window covering simply by restoring the tension on the operating loop by pulling on the operating loop. This is against the latest child safety regulations as described in the Standard for Safety of Window Covering Products approved by the American National Standards Institute on Dec. 13, 2022, (ANSI/WCMA A100.1-2022). Herein it is stipulated that if the tension device is installed in a location that does not maintain tension on the operating loop, the tension device will prevent the window covering from operating as designed for full operation of the product.

The invention has for its object to provide a tension device for an endless operating loop that does fulfil these latest requirements for child safety, as described in the ANSI/WCMA A100.1-2022.

Thereto the tension device according to the invention further comprises a locking element for locking the slidable member in a locked position in the housing, wherein in the locked position of the slidable member the one or more immobilization elements immobilize the endless operating loop in the non-operating position.

In use the endless operating loop default assumes an operating position, as long as the slidable member is in the free position. The biasing member continuously pushes the slidable member towards the locked position. When the tension on the endless operating loop decreases, the locking element actually locks the slidable member in a locked position, wherein the immobilization elements block the operating loop in the non-operating position. The operating loop is no longer operable, not even when it is pulled upon. The user is forced to unlock the slidable member from the locked position to a free position. Additionally the user must restore the tension on the operating loop, because otherwise the slidable member will be pushed into the locked position again by the biasing member and the operating loop will automatically be blocked again in the non-operating position. The operation is independent whether the tension device is attached to a substrate or not.

In a compact preferred embodiment of the tension device according to the invention the locking element is arranged on the slidable member and the housing comprises a receiving space for the locking element. Preferably the receiving space is located in the lower part of the housing. In normal use of the tension device the biasing member pushes the slidable member in a downward direction, which is consequently directed towards the locked position.

In an elegant, preferred embodiment of the tension device according to the invention the locking element comprises a hook and the receiving space comprises a recess in the wall of the housing. Preferably the locking element is part of a snap-fit connection.

According to a further preferred embodiment of the tension device according to the invention the tension device further comprises an unlocking element adapted for unlocking the slidable member from the locked position to a free position. Preferably the unlocking element is arranged on the housing. Alternatively the unlocking element can be a separate tool.

In a further elaboration of the compact preferred embodiment the unlocking element is arranged to enlarge the receiving space. Consequently the locking element can easily escape from the receiving space.

In another elegant, preferred embodiment of the tension device according to the invention the unlocking element is a push button. A push button is suitable for repeated activation by a user.

In a compact design the unlocking element comprises a flexible wall part in the housing.

According to another preferred embodiment of the tension device according to the invention the one or more immobilization elements are adapted for clamping the operating loop.

According to a first preferred embodiment of the tension device according to the invention the one or more immobilization elements comprise first engaging elements adapted for engaging a bead chain. According to a further elaboration of the first preferred embodiment the slidable member in the locked position and the first engaging elements enclose the endless operating loop. Preferably the first engaging elements comprise one or more forks to engage on the chain between adjacent beads.

According to a second preferred embodiment of the tension device according to the invention the one or more immobilization elements comprise second engaging elements adapted for clamping a cord. According to a further elaboration of the second preferred embodiment the second engaging elements comprise a wheel and one or more ledges to clamp the cord between. Preferably the wheel is suspended eccentrically in the housing thereby further increasing the reliability of the second preferred embodiment.

Preferably the biasing member comprises one or more springs.

The tension device according to the invention is especially suitable for use in an endless operating loop of a window covering.

The invention will now be described in more detail with reference to the figures.

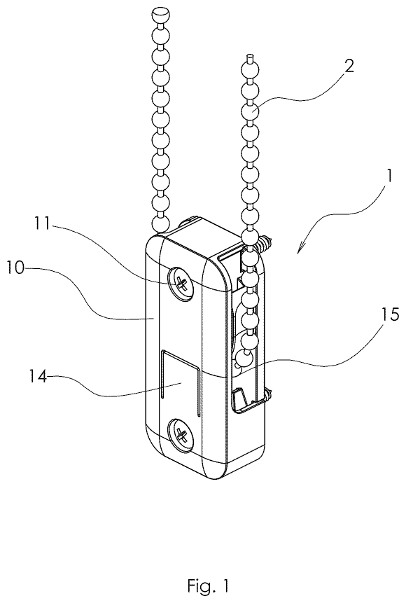

FIG. 1 shows a schematic view of a first preferred embodiment of a tension device according to the invention;

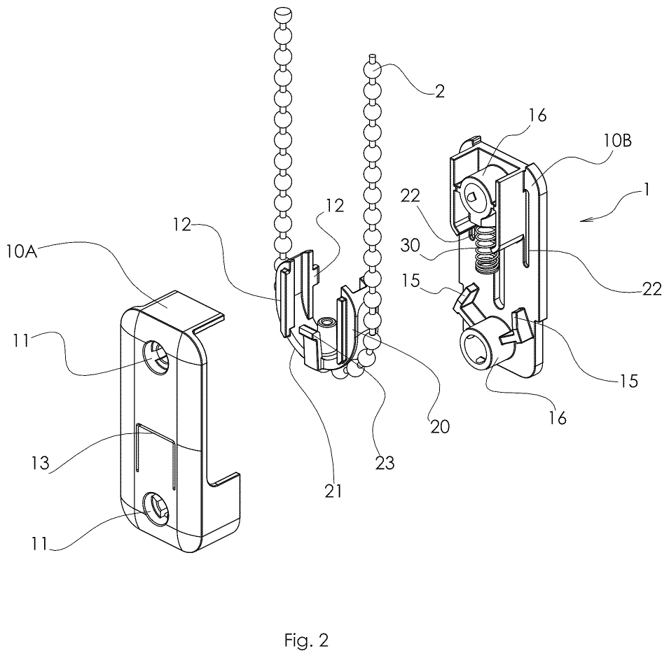

FIG. 2 shows the tension device of FIG. 1 with exploded parts;

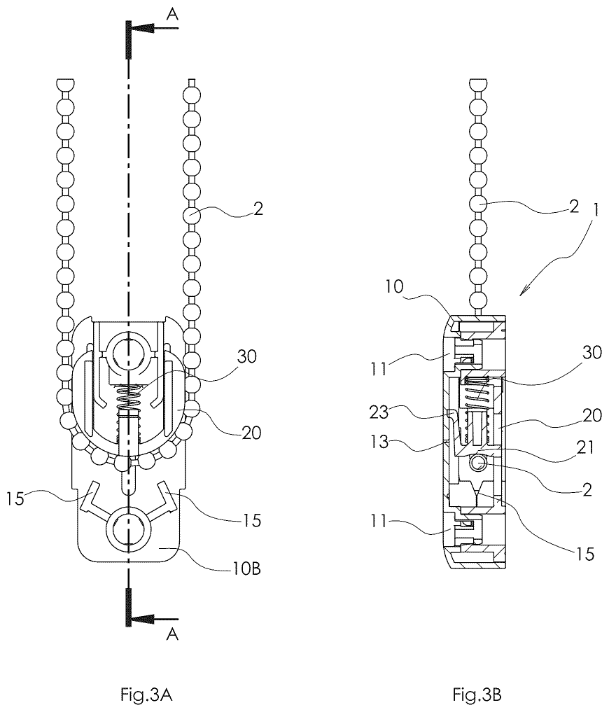

FIG. 3A shows a front view of the tension device of FIG. 1 in a free position with a part broken away;

FIG. 3B shows a cross sectional view along the line A of FIG. 3A;

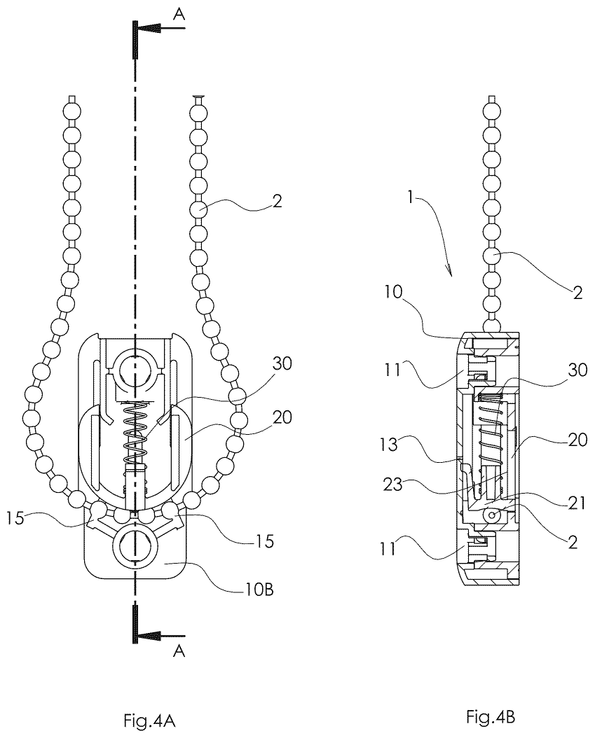

FIG. 4A shows a front view of the tension device of FIG. 1 with a part broken away in a locked position;

FIG. 4B shows a cross sectional view along the line A of FIG. 4A;

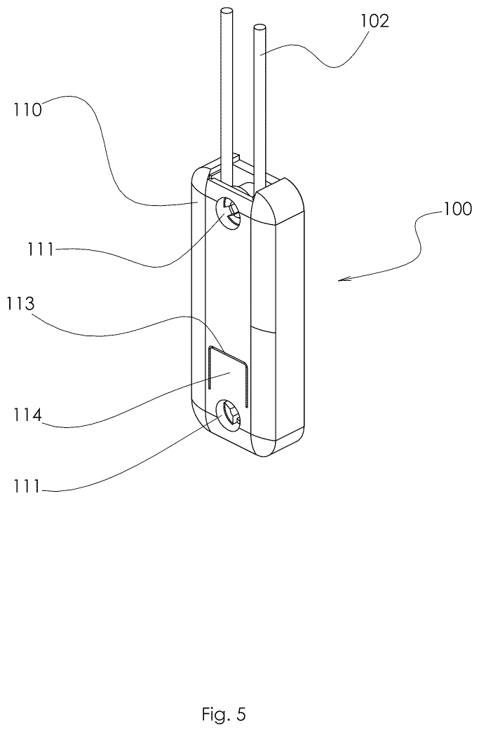

FIG. 5 shows a schematic view of a second preferred embodiment of a tension device according to the invention;

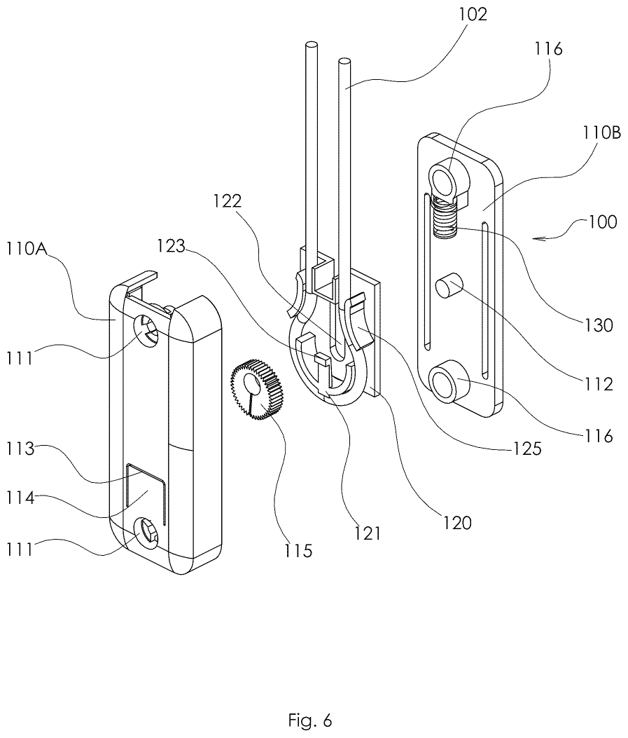

FIG. 6 shows the tension device of FIG. 5 with exploded parts;

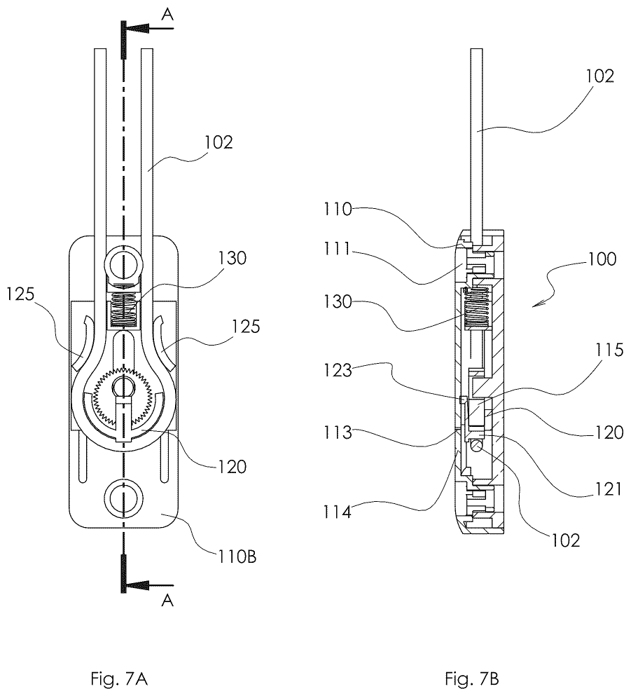

FIG. 7A shows a front view of the tension device of FIG. 5 with a part broken away in a free position;

FIG. 7B shows a cross sectional view along the line A of FIG. 7A;

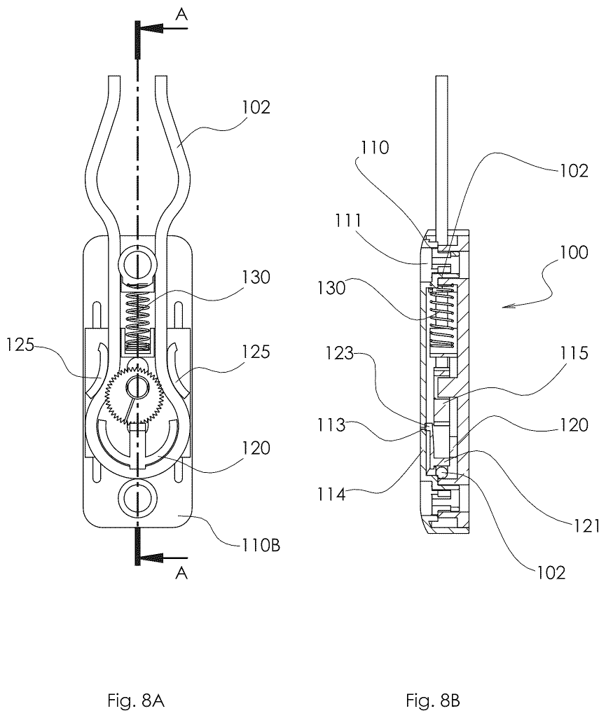

FIG. 8A shows a front view of the tension device of FIG. 5 with a part broken away in a locked position; and

FIG. 8B shows a cross sectional view along the line A of FIG. 8A.

FIG. 1 illustrates schematically a first preferred embodiment of a tension device 1 according to the invention. In the first preferred embodiment the tension device 1 is suitable for use as a safety device in an endless chain for operation of a screen, such as a window covering. Shown by way of illustration is a bead chain 2. The tension device 1 comprises a housing 10, wherein a portion of the endless operating chain 2 is received.

FIG. 2 shows the tension device of FIG. 1 with exploded parts. It can be seen that the housing 10 comprises a front part 10A and a back part 10B. The housing 10 comprises a loop guide 21 for the chain 2. The loop guide 21 is arranged slidable in the housing 10. In the first preferred embodiment the housing 10 comprises a slidable member 20 on which the loop guide 21 is arranged. Thereto the housing 10 respectively the slidable member 20 comprise cooperating sliding means, such as slide rails 12 respectively slide recesses 22.

The housing 10 can be fastened to a structure and is thereto provided with fastening openings 11, 16 for screws.

The housing 10 further comprises a biasing member 30 that is arranged to push against the slidable member 20 to apply tension to the chain 2. In normal use of the tension device 1 the biasing member 30 pushes in a downward direction, substantially parallel to the chain 2. In the first preferred embodiment the biasing member comprises a spring 30. One end of the spring 30 is fastened in the housing 10 and the other, opposite end of the spring 30 is fastened to the slidable member 20.

The slidable member 20 is further provided with a locking element 23 that is arranged for locking the slidable member 20 in a locked position in the housing 10. In the first preferred embodiment the locking element comprises a resilient hook 23. The housing 10 is provided with a receiving space 13 to accommodate the locking element 23. In the first preferred embodiment the receiving space comprises a recess 13 in the wall of the front housing part 10A, more specifically in the lower half thereof. Preferably the locking element 23 and the receiving space 13 form a snap-fit connection.

The housing 10 comprises one or more immobilization elements 15 that are arranged to engage on the chain 2 and to substantially immobilize the chain 2 in a non-operating position when the slidable member 20 is in the locked position. The one or more immobilization elements comprise first engaging elements 15 for engaging the bead chain 2. The first engaging elements comprise one or more forks 15 to engage on the chain 2 between adjacent beads.

The housing 10 comprises an unlocking element 14 that is arranged to unlock the slidable member 20 from the locked position to allow it to return to a free position in which the chain 2 is in an operating position. The unlocking element 14 is arranged to enlarge the receiving space 13 to allow the locking element to snap out of the receiving space. The unlocking element comprises a flexible wall part 14 of the housing 10 adjacent the recess 13 that can be pushed in and forms a push button. Here the flexible wall part 14 is cut out on three sides.

FIG. 3A shows a front view of the tension device 1 in the free position with the first housing part broken away and FIG. 3B shows a cross sectional view along the line A of FIG. 3A. The chain 2 is in an operating position and the slidable member 20 is in the free position. The spring 30 pushes the slidable member 20 towards the locked position. The chain tension prevents the locking element 23 from clicking in the receiving space 13 and consequently keeps the slidable member 20 out of the locked position. There exists a balance between the tension force of the spring 30 and the tension force of the chain 2.

FIG. 4A shows a front view of the tension device 1 in the locked position with the first housing part broken away and FIG. 4B shows a cross sectional view along the line A of FIG. 4A. As shown the tension on the chain 2 has dropped and consequently the balance is disturbed and the spring 30 pushes the slidable member 20 into the locked position. The chain 2 gets enclosed between the slidable member 20 and the first engaging means 15 and assumes a non-operable position.

The user now needs to push the unlocking element 14 to free the slidable member 20 from the locked position and restore the tension on the chain 2 to bring it in the operable position again.

FIG. 5 illustrates schematically a second preferred embodiment of a tension device 100 according to the invention. In the second preferred embodiment the tension device 100 is suitable for use as a safety device in an endless cord 102 for operation of a screen, such as a window covering. The tension device 100 comprises a housing 110, wherein a portion of the endless operating cord 102 is received.

FIG. 6 shows the tension device of FIG. 5 with exploded parts. It can be seen that the housing 110 comprises a front part 110A and a back part 110B. The housing 110 comprises a loop guide 121 for the cord 102. The loop guide 121 is arranged slidable in the housing 110. In the second preferred embodiment the housing 110 comprises a slidable member 120 on which the loop guide 121 is arranged. Thereto the housing 110 respectively the slidable member 120 comprise cooperating sliding means, such as a slide pin 112 respectively a slide opening 122.

The housing 110 can be fastened to a structure and is thereto provided with fastening openings 111, 116 for screws.

The housing 110 further comprises a biasing member 130 that is arranged to apply tension to the cord 102 by pushing against the slidable member 120. In normal use of the tension device 100 the biasing member 130 pushes in a downward direction, substantially parallel to the cord 102. In the second preferred embodiment the biasing member comprises a spring 130. The spring 130 is fastened at one end in the housing 110 and at the other, opposite end the spring 130 is fastened to the slidable member 120.

The slidable member 120 is further provided with a locking element 123 that is arranged for locking the slidable member 120 in a locked position in the housing 110. Preferably the locking element 123 and the receiving space 113 form a snap-fit connection. In the second preferred embodiment the locking element comprises a resilient hook 123. The housing 110 is provided with a receiving space 113 to accommodate the locking element 123. In the second preferred embodiment the receiving space comprises a recess 113 in the wall of the front housing part 110A, more specifically in the lower half thereof.

The housing 110 comprises one or more immobilization elements 115, 125 that are arranged to engage on the cord 102 and to substantially immobilize the cord 102 in a non-operating position when the slidable member 120 is in the locked position. In the second preferred embodiment the one or more immobilization elements comprise second engaging elements 115, 125 for engaging the cord 102. The second engaging elements comprise a wheel 115 arranged in the housing 110 and two ledges 125 arranged on the slidable member to clamp the cord 102 against the wheel. The wheel has a rough perimeter to improve the clamping of the cord. An example of a suitable wheel is a toothed wheel. In the second preferred embodiment the wheel 115 is arranged eccentrically. The wheel 115 has an eccentric hole that makes it tilt either to the left or to the right to clamp the cord 102 against the left or right ledge.

The housing 110 comprises an unlocking element 114 that is arranged to unlock the slidable member 120 from the locked position to allow it to return to a free position in which the cord 102 is in an operating position. The unlocking element 114 is arranged to enlarge the receiving space 113 to allow the locking element to snap out of the receiving space. The unlocking element comprises a flexible wall part 114 of the housing 110 adjacent the recess 113 that can be pushed in and forms a push button. Here the flexible wall part 114 is cut out on three sides.

FIG. 7A shows a front view of the tension device 100 in the free position with the first housing part broken away and FIG. 7B shows a cross sectional view along the line A of FIG. 7A. The cord 102 is in an operating position and the slidable member 120 is in the free position. The spring 130 pushes the slidable member 120 towards the locked position. However, the cord tension prevents the locking element 123 from clicking in the receiving space 113 and consequently keeps the slidable member 120 out of the locked position. There exists a balance between the tension force of the spring 130 and the tension force of the cord 102.

FIG. 8A shows a front view of the tension device 100 in the locked position with the first housing part broken away and FIG. 8B shows a cross sectional view along the line A of FIG. 8A. As shown the tension on the cord 102 has dropped and consequently the balance is disturbed and the spring 130 pushes the slidable member 120 into the locked position. The cord 102 engages the wheel 115 and the wheel turns to the left in FIG. 8A, where it clamps the cord 102 against the ledge 125 and the cord 102 assumes a non-operable position.

The user now needs to push the unlocking element 114 to free the slidable member 120 from the locked position of FIG. 8A and restore the tension on the cord 102 to bring it in the operable position again.

The invention is of course not limited to the described and shown preferred embodiments. For instance, in both preferred embodiments an unlocking element is arranged on the housing. Alternatively, a separate tool may be used to unlock the slidable element from the locked position into the free position. One example of a suitable separate tool is a ball point pen that may be inserted in a suitable hole in the housing and be used to push against the locking element.

Consequently the present invention extends to any embodiment falling within the scope of protection as defined in the claims and as seen in the light of the foregoing description and accompanying drawings.

1. A tension device for an endless operating loop of a screen, wherein the tension device comprises:
a housing for receiving part of the endless operating loop;
a slidable member arranged in the housing;
wherein the slidable member is provided with a loop guide for the endless operating loop;
a biasing member arranged in the housing to push against the slidable member to apply tension to the endless operating loop;
one or more immobilization elements arranged in the housing that substantially immobilize the endless operating loop in a non-operating position upon engagement with the endless operating loop; and
a locking element for locking the slidable member in a locked position in the housing, wherein in the locked position of the slidable member the one or more immobilization elements immobilize the endless operating loop in the non-operating position.

2. The tension device according to claim 1, wherein the locking element is arranged on the slidable member and the housing comprises a receiving space for the locking element.

3. The tension device according to claim 2, wherein the receiving space is located in the lower part of the housing.

4. The tension device according to claim 2, wherein the locking element comprises a hook and the receiving space comprises a recess in the wall of the housing.

5. The tension device according to claim 2, wherein the locking element is part of a snap-fit connection.

6. The tension device according to claim 1, wherein the tension device further comprises an unlocking element adapted for unlocking the slidable member from the locked position to a free position.

7. The tension device according to claim 6, wherein the unlocking element is arranged on the housing.

8. The tension device according to claim 6, wherein the housing comprises a receiving space for the locking element and the unlocking element is arranged to enlarge the receiving space.

9. The tension device according to claim 7, wherein the unlocking element is a push button.

10. The tension device according to claim 7, wherein the unlocking element comprises a flexible wall part in the housing.

11. The tension device according to claim 1, wherein the one or more immobilization elements are adapted for clamping the operating loop.

12. The tension device according to according to claim 1, wherein the one or more immobilization elements comprise first engaging elements adapted for engaging a bead chain.

13. The tension device according to claim 12, wherein the slidable member in the locked position and the first engaging elements enclose the endless operating loop.

14. The tension device according to claim 12, wherein the first engaging elements comprise one or more forks to engage on the chain between adjacent beads.

15. The tension device according to claim 1, wherein the one or more immobilization elements comprise second engaging elements adapted for clamping a cord.

16. The tension device according to claim 15, wherein the second engaging elements comprise a wheel and one or more ledges to clamp the cord between.

17. The tension device according to claim 16, wherein the wheel is suspended eccentrically in the housing.

18. The tension device according to claim 1, wherein the biasing member comprises one or more springs.

19. The tension device according to claim 1, wherein the screen is a window covering.
